(19) United States
(12) Patent Application Publication
(10) Pub. No.: US 2008/0198580 A1
(43) Pub. Date: Aug. 21, 2008

(54) Light attachment

(76) Inventors: Bretislav Kostal, Prague (CZ); Vladimir Kupa, Prague (CZ)

Correspondence Address: COLLARD & ROE, P.C., 1077 NORTHERN BOULEVARD, ROSLYN, NY, 11576, US

(21) Appl. No.: 11/821,886

(22) Filed: Jun. 26, 2007

(30) Foreign Application Priority Data
Feb. 16, 2007 (CZ) CZ PV 2007-127

(51) Int. Cl. F21L 4/00; F21V 21/08

(52) U.S. Cl. 362/108; 362/157; 362/191

(57) ABSTRACT

A light attachment for fastening to a carrier structure including a light source (4), a battery (5) and a light source controlling switch (23) comprising a casing (1) with a front side and a rear side and including a head portion (16) with a first opening (17) for the light source (4) in the front side and an elongated body portion with a second opening for a switch actuating arm in the front side and further comprising a removable elastic sleeve (6) for surrounding at least partially the elongated body and the carrier structure to urge and fasten the rear side of the casing (1) to the carrier structure.

### FIELD OF THE INVENTION

This invention relates to a light attachment for fastening to a carrier structure comprising a light source, battery and a light source-controlling switch and means for attaching it to a carrier structure in combination with which the light attachment may be used. The carrier structure may be a self-defense device such as a defense-spray containers, batons, clubs, or other carriers serving various purposes such as walking sticks, ski sticks etc. In combination with a self-defense device, the flashlight of the light attachment should help the intended victim or a law enforcement personnel to allocate the assailant's face and/or to partially blind and deter him or subsequently to apply the defending spray or a baton if the assailant continues in his action

### DESCRIPTION OF THE PRIOR ART

There are many types of combined devices known in the art. The most of them are based on a conventional concept of a torch or battery lamp that is adapted for mounting on a self-defense spray container or a baton. As disclosed in the U.S. Pat. No. 5,086,377 such a defense device may consist of a middle portion comprising a defending spray and an end portion with a light and sound alarm device. Such a device is big in size and therefore not suitable to be carried in a handbag or pocket.

From the U.S. Pat. No. 5,549,220 a pistol-shape device is known that includes in a housing a storage battery, two lamps emitting blue and white light respectively, a sound source and a chemical repellent container. The device includes at least three separate compartments, internal wiring and piping to provide the respective connections between the operating switches, battery, lamps and a gas nozzle. The device is operated by two switches and a trigger what may be rather confusing in the situation when it should be used against an unexpected assailants and therefore very quickly and with an immediate and surprising effect. Moreover, due to its considerable size such device is not suitable to be carried in a handbag specifically in women shoulder bag or a clutch bag or a pocket.

U.S. Pat. No. 5,373,427 discloses a device having a shape of a conventional elongated torch housing serving as a holder with a lamp emitting light substantially in a right angle to the torch holder and disposed at the upper end thereof. A self-defense spray container is inserted in the housing below the lamp and the lower interior part of the housing is occupied by a battery pack. The access to the spray-activating button on the container is covered by a rotational cover, which when lifted in its upper position operates as a switch connecting the terminals of the lamp and batteries to activate the emission of light. In the lower closed position, the cover surface is leaning towards the vertically biased exterior portion of the housing and closes the opening providing otherwise the access to the spray-actuating button. In use by the defender, the cover must be first allocated then gripped by a finger and lifted. The time necessary for taking such actions may be critical one in view of the condition of a victim exposed to a sudden or unexpected assailant's attack. Moreover, the design where the lamp is separated from batteries by a spray container requires rather complicated connection between the lamp, battery and switch and relatively big dimensions like with the above-described devices.

U.S. Pat. No. 6,676,270 discloses a device combining a self-defense spray container and a light source whereby as a light source a LED diode and as an accumulator a button-type battery is used. This solution makes possible to reduce considerably the size of the device as a whole and to enable various mutual configuration of its individual elements. According to one of such embodiments, both the light source and the spray may be actuated by a single pressing button. Nevertheless, the adaptation to various types of spray containers is rather complicated.

Another variance of said type combined device shows U.S. Pat. No. 7,121,432, which prevents spontaneous manipulation while enabling an easy and quick control of the light source and the spray. Like in the previous case, the dimensions of the light source attachment shall correspond always to a certain type of spray container and it cannot be used for another type of a container or even another type of a self-defense device.

It is therefore the primary object of the invention to provide a light attachment of a universal shape that could be used in combination with various types and sizes of self-defense devices including spray defense containers and batons as well as in combination with other equipments and accessories.

Another object of the invention is to provide a specific structure of the light attachment adapted to receive miniaturized components and enabling thus to minimize the size of the light attachment so that it can be used in conjunction with a specific fastening means.

Still another object of the invention is to provide a light attachment, which may be easily attached to and released from a carrier structure by a specific means, which, in addition, provide a comfort and safe handgrip and holding of a combined self-defense device.

### SUMMARY OF THE INVENTION

A light attachment for fastening to a carrier structure according to the invention including a light source, a battery and a light source controlling switch comprises a casing with a front side and a rear side and including a head portion with a first opening for the light source in the front side and an elongated body portion with a second opening for a switch actuating arm in the front side and further comprising a removable elastic sleeve for surrounding at least a partially the elongated body and the carrier structure to urge and fasten the rear side of the casing to the carrier structure.

To minimize the size of the light attachment and render it adaptable for various carrier structures the casing of the light attachment has a substantially wedge-shaped structure tapered on the front side and widened on the rear side. Further, the casing includes two lateral beams joined together by the top head portion at one end and by a bottom at the other end. The switch-actuating arm is located between the beams and mounted for rocking motion on the front edges of the beams through lateral pivots and the front edges of the beams are provided with recesses for receiving said lateral pivots.

Further, in connection with said aspects of the invention, it is preferred that the beams are connected by a baffle partitioning the internal space of the casing between the head and the bottom into a switch compartment and a battery compartment.

To enable a save and easy grip, the outer surface of the elastic sleeve has a selectively embossed structure. More specifically, the outer surface of the elastic sleeve has a specific knurling in the area covering the switch-actuating arm and is separated by a boss from the other embossed structure of the front side.

Alternatively, where the light attachment is used in combination with larger structures or where the elastic sleeve shall pass through a hole in the carrier structure the elastic sleeve may be in a form of a belt provided with connecting means on its ends.

In preferred embodiments, the light attachment is combined with such carrier structures as a self-defense spray container or a baton.

### BRIEF DESCRIPTION OF THE DRAWINGS

Further objects of the present invention together with additional features contributing thereto will be apparent from preferred embodiments of the invention as illustrated in the accompanying drawings with certain figures on a larger scale wherein:

FIG. 1 is a perspective front view of a light attachment fastened to a self-defense spray container;

FIG. 2 is a perspective side view of light attachment fastened to a self-defense spray container;

FIG. 3 is a sectional side view of the light attachment shown in FIG. 2;

FIG. 4 is an exploded view showing a side and a front view of the casing structure and parts incorporated therein;

FIG. 5 is a perspective side view of the light attachment fastened to a police baton.

### DETAILED DESCRIPTION OF THE PREFERRED EMBODIMENT

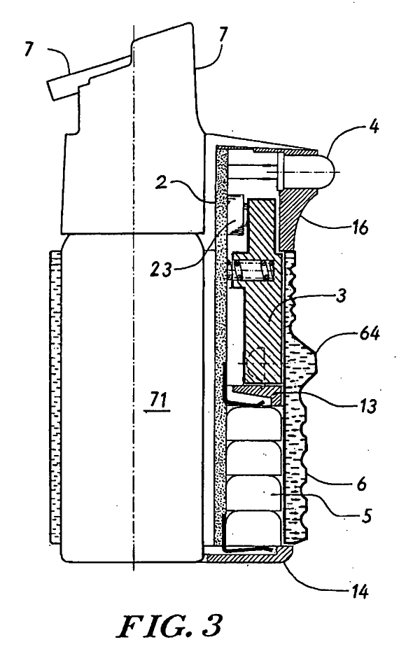

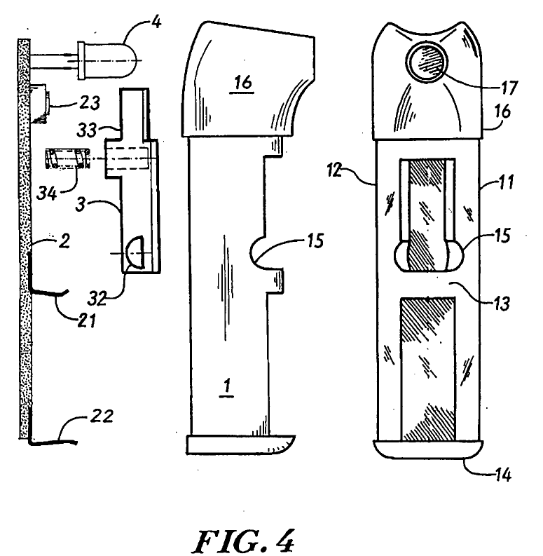

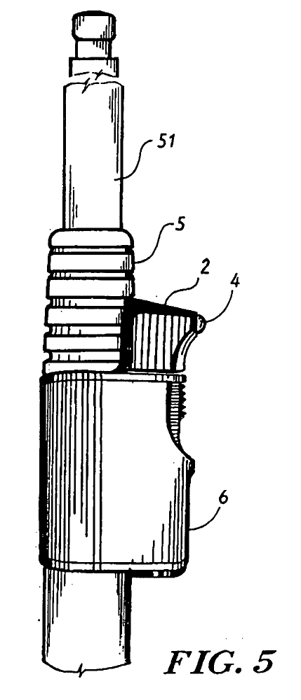

The light attachment according to the invention shown in detail in FIG. 3 and in exploded view in FIG. 4 includes a casing 1, consisting of two elongated lateral beams 11, 12 joined together by a common head 16 at their top ends and by a bottom 14 at their lower ends. The beams 11, 12 form together with the head 16 and the bottom 14 a wedge shaped structure with a tapered front side and a widened rear side. The widened rear side is designed to engage a body of a carrier structure, to which the light attachment shall be fastened. Further, the beams 11, 12 are connected on the front side by a transverse baffle 13 partitioning the interior space of the casing 1 between the head 16 and the bottom 14 into a switch compartment and a battery compartment. On the front side, the head 16 has an opening 17 occupied by the light beam emitting part of the light source 4—in this embodiment a light emitting diode/LED/. The switch compartment above the baffle 13 is occupied by a switch actuating arm 3 provided with a contact end 33 and lateral pivots 32 through which the actuating arm 3 is mounted for rocking motion on the circular recesses 15 made in the front side edges of the beams 11,12. The battery compartment is occupied by a battery source 5, in the present embodiment represented by a button-type batteries pack.

The rear side of the casing 1 is closed by a cover board 2 which carries the light source 4, a switch 23 and battery contacts 21, 22. The cover board 2 includes the respective wiring or printed circuits for providing the connection of the battery source 5 to the light source 4 over the switch 23. The switch 23 is actuated by the contact end 33 of the manually operated switch-actuating arm 3. The contact end 33 of the switch-actuating arm 3 is held in the disengaged position with respect to the switch 23 by a pressure spring 34. The outer surface of the cover board is slightly curved inwards so that it engages a carrier structure preferably by its marginal longitudinal edges to secure its stabile position of the light source with respect to the carrier structure body.

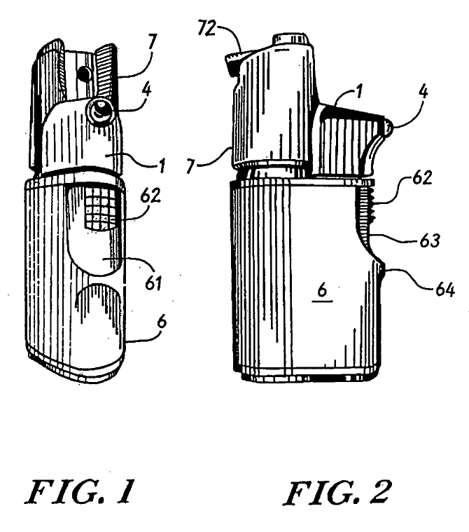

Another part of the light attachment is an elastic sleeve 6 illustrated in section in FIG. 3 and having an outer shape as shown in FIGS. 1, 2 and 5. The elastic sleeve 6 is designed for fastening the light attachment to a various carrier structures, which, by way of example, are represented by a spray-defense apparatus 7 shown in FIG. 1a 2 and a police baton 5 in FIG. 5. It is to be noted that in FIGS. 1, 2 and 5, the light attachment and the carriers are shown in real scale to enable one to get the picture of the minimal real size of the light attachment. The spray-defense apparatus 7 in FIGS. 1, 2 and 3 includes a conventional spray container 71 of a cylindrical shape, a cap comprising an internal valve, a gas outlet nozzle and a valve-actuating button 72. The casing 1 leans by its widened rear side towards the wall of the spray container 71. The elastic sleeve 6 surrounds the front part of the casing 1 and the opposite circular surface of the spray container 71 and by the effect of tension forces accumulated in the elastic sleeve 6 by its previous forced stretching and putting it on the spray container 71 urges the casing 1 towards the adjacent circular surface of the spray container 71. The so exerted pressure ensures a safe fastening of the casing 1 to the spray container 71 in a predetermined mutual position. Nevertheless, the preferred position is that, where the axis of the spray outlet nozzle and the axis of the LED light beam are parallel and share the same vertical plain. In the embodiment of FIG. 5, the light attachment is fastened by the elastic sleeve 6 to a cylindrical handle of a police baton 5 including a telescopic shaft 51 shown in its extended configuration.

To enable an easy grip and control, the elastic sleeve 6 is on its outer side provided with a selectively embossed structure 63 and at the area contacting the switch actuating arm 3 with a specific knurling 62 in a recess 61 separated by a boss 64 from the other embossed structure on the front side. The boss 64 projects slightly over the front side plane and the recess 61 so that it avoids spontaneous engaging the switch actuating 3 arm when, in circumstances, the carrier structure is urged against a rigid surface on the side of the light attachment.

In use, the valve-actuating button 72 is controlled by thumb while the switch actuating arm 3 by forefinger or another finger at the area of the specific knurling 62 of the elastic sleeve 6 covering the switch-actuating arm 3. An inoperable empty spray container 71 may be easily replaced by taking down the elastic sleeve 3 and pulling it on the existing light attachment and a new spray container 71. The elastic sleeve 3 may be produced as a ring, endless belt or a elastic strip made for example from a suitable rubber composition, wherein the elastic strip may be provided with connecting means at its ends such as “Velcro”-type fasteners etc. The latter embodiment may be practical in combination with larger carrier structures or where the elastic sleeve 3 shall pass through a hole in the carrier structure.

### INDUSTRIAL APPLICABILITY

As indicated above, the light attachment is not designed only for its use in combination with a spray-defense apparatus or a baton as described above but it may be used in combination with a club, walking stick, ski stick, or any object including a portion to which, with respect to its shape and size, the light attachment may be fastened by an elastic sleeve.

1. A light attachment for fastening to a carrier structure including a light source, a battery and a light source controlling switch comprising:
a casing with a front side and a rear side including a head portion with a first opening for the light source in the front side and an elongated body portion with a second opening in the front side;
a switch actuating arm in the front side located in said second opening;
a removable elastic sleeve for surrounding at least a part of the elongated body portion and a part of the carrier structure to urge and fasten the rear side of the casing to the carrier structure.

2. The light attachment according to claim 1, wherein the casing has a substantially wedge-shaped structure tapered on the front side and widened on the rear side.

3. The light attachment according to claim 1, wherein the casing includes two lateral beams joined together by the head portion at one end and by a bottom at the other end.

4. The light attachment according to claim 3, wherein the switch actuating arm is located between the beams and mounted for rocking motion on the front edges of the beams through lateral pivots and the front edges of the beams are provided with recesses for receiving said lateral pivots.

5. The light attachment of claim 3, wherein the beams are connected by a baffle dividing the internal space of the casing between the head portion and the bottom into a switch compartment and a battery compartment.

6. The light attachment of claim 1, wherein the outer surface of the elastic sleeve has a selectively embossed structure.

7. The light attachment of claim 6, wherein the outer surface of the elastic sleeve has a specific knurling in the area covering the switch actuating arm separated by a boss from the other embossed structure of the front side.

8. The light attachment of claim 1, wherein the elastic sleeve is a belt provided with connecting means at its ends.

9. The light attachment of claim 1, wherein the carrier structure is a spray-defense apparatus.

10. The light attachment of claim 1, wherein the carrier structure is a baton.

11. A light attachment for fastening to a carrier structure including a light source, a battery and a light source controlling switch comprising:
a casing of a substantially wedge-shaped structure tapered on the front side and widened on the rear side including two lateral beams forming an elongated body joined together by a head portion at one end and by a bottom at the other end;
a first opening for the light source in the front side of the head portion;
a second opening in the front side of the elongated body;
a switch actuating arm located in said second opening and mounted for rocking motion on said lateral beams;
a removable elastic sleeve for surrounding at least a part of the elongated body portion and a part of the carrier structure to urge and fasten the rear side of the casing to the carrier structure.

12. A light attachment for fastening to a carrier structure including a light source, a battery and a light source controlling switch comprising:
a casing of a substantially wedge-shaped structure tapered on the front side and widened on the rear side including two lateral beams forming an elongated body joined together by the top head portion at one end and by a bottom at the other end;
a cross baffle between the lateral beams and dividing the internal space of the casing between the head portion and the bottom into a switch compartment and a battery compartment;
a first opening for the light source in the front side of the head portion;
a second opening in the front side of the elongated body;
a switch actuating arm located in said second opening between the beams and mounted for rocking motion on the beams;
means for fastening the light attachment to the carrier structure.
